(19) United States
(12) Patent Application Publication
(10) Pub. No.: US 2023/0050881 A1
(43) Pub. Date: Feb. 16, 2023

(54) Systems and/or Methods for Funding and Developing Social Internet Businesses

(71) Applicant: Christopher Daniels, New York, NY (US)

(72) Inventor: Christopher Daniels, New York, NY (US)

(21) Appl. No.: 17/732,360

(22) Filed: Apr. 28, 2022

Related U.S. Application Data
(60) Provisional application No. 63/233,503, filed on Aug. 16, 2021.

(51) Int. Cl. G06Q 40/04

(52) U.S. Cl. CPC G06Q 40/04

(57) ABSTRACT

Certain exemplary embodiments can provide a method, which comprises creating a stockholder table. The stockholder table created and maintained on a machine-readable medium. The method comprises automatically detecting registration for, and use of, a subscription service accessed via the Internet by a user. The method comprises, responsive to detected registration for, and use of, the subscription service, automatically changing the stockholder table to add the user as a shareholder of the subscription service.

### CROSS-REFERENCES TO RELATED APPLICATIONS

This application claims priority to, and incorporates by reference herein in its entirety, U.S. Provisional Patent Application Ser. No. 63/233,503 (Attorney Docket No. 1571-02), filed Aug. 16, 2021.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 illustrates two flowcharts of exemplary embodiments of methods;

FIG. 2 illustrates a flowchart of an exemplary embodiment of a method;

FIG. 3 illustrates two flowcharts of exemplary embodiments of methods;

FIG. 4 illustrates a block diagram of an exemplary embodiment of a system and data flow in the system;

FIG. 5 illustrates a block diagram of an exemplary embodiment of a system decision framework;

FIG. 6 is a side view of an exemplary embodiment of a system 6000;

FIG. 7 is a block diagram of an exemplary embodiment of an information device 7000; and

FIG. 8 is a flowchart of an exemplary embodiment of a method 8000.

### DETAILED DESCRIPTION

Certain exemplary embodiments can provide a method, which comprises creating a stockholder table. The stockholder table created and maintained on a machine-readable medium. The method comprises automatically detecting registration for, and use of, a subscription service accessed via the Internet by a user. The method comprises, responsive to detected registration for, and use of, the subscription service, automatically changing the stockholder table to add the user as a shareholder of the subscription service.

Certain exemplary embodiments provide a method for funding and developing one or more social networking businesses (where a “social networking business” is defined as a business whose value is a function of the number of users (the “users”) of the company's services where: (a) the company provides an interface (meaning an input/output function) for users; (b) where the interface enables interaction among those who use it via a electronic network that is capable of scaling up quickly to include thousands or even millions of connections [such as the Internet] and (b) users contribute personal-data and other content to the network; and (c) a substantially significant portion of the revenue is generate by a third-party, typically advertisers, who pay for access to users) by effectively bypassing the traditional investors who buy stock from a company for cash. The result of this method is that social network users will own a substantial portion of the equity of the network operator, where “equity” means one or more series of common stock or securities convertible or exchangeable for common stock. Users become owners of the network operator and benefit from such ownership by gaining the value of their collective social activity as represented by the price of the common stock they hold in the network operator and, via equity, the users gain means of participating in governance of the network operator.

Methods disclosed herein are implemented via improvements to information device functionality and/or machine instruction functionality. Those skilled in the art will recognize that improvements to functionality can be implemented via hardware, software, and/or a combination of hardware and software.

Certain exemplary embodiments provide a method that allows a certain type of early-stage business to be funded rapidly and develop to serve millions of people. The method greatly improves upon other processes for funding and developing businesses. Certain methods disclosed herein are applicable to businesses that operate systems in which customers contribute personal data and/or make other personal contributions as to online content. Such methods can be applicable to social networking and other social Internet companies and are a novel advance over prior methods. Certain exemplary embodiments provide a method that substantially shortens the time of business development and market penetration and utilizes computerized systems and other technologies to scale rapidly. Ability to scale quickly is a factor in the success of any business but especially relevant to a social business. As an added benefit, Certain exemplary embodiments achieve a more inclusive and equitable outcome in which the customers of such a business can share in the value created from their data and other contributions

Historically, entrepreneurs have sold equity, typically common stock, to investors to generate cash to fund their business. This funding mechanism is utilized for businesses that require substantially more capital than one single person is willing to risk on investing in a new enterprise, generally more than $500,000, and where the enterprise plans to grow to achieve a substantial value, generally more than $5,000,000. The proceeds of sales of stock and other securities can be used to produce goods and to deliver services to customers. In certain circumstances, the customers have a little or no role in the creation of products and services for the business—instead they are simply purchasers of goods and services at market prices.

Social Internet businesses are different from other kinds of businesses in ways that most people still do not fully comprehend. For example, the number of people who use a social Internet company's platform to connect with other people (known as the “users”), is a factor in a social Internet company's value. The Internet makes it possible to connect millions, if not billions, of people through electronic devices The fact that user scale makes it possible for social-focused business models to gain value is a key factor in that led to this invention of the novel improvements to prior art hardware and/or software and disclosed herein.

The social Internet is a relatively new phenomenon. In certain instances, social Internet organizations utilize traditional (historical) funding methods that comprise selling shares to investors who provide cash that might be used to fund the development of the business and create a means of producing products and services. In such a model, founders and investors capture much of the economic value of an enterprise and the customers gain none of that economic value. Historically, it has been impossible for a business to offer equity to all its customers because United States securities laws, rules and regulations have prohibited unregistered public offers of securities and the sale and transfer of equity, such as common stock, and other securities to those who do not meet certain qualifying criteria related to personal assets or income (known as “accredited investor criteria”) such as holding assets with a value of at least $1 million Recent changes to securities rules and regulations now make it possible, for the first time in at least 85 years, to offer unregistered equity securities and to advertise the offer publicly. The methods disclosed herein are distinct from, and superior to, such traditional stock issuance processes. Methods disclosed herein achieves benefits over prior art systems and provides a lower cost, more flexible, and more efficient process for issuance in social media company ownership shares without human approval or intervention in issuance of such ownership shares.

Advertising of stock offerings has historically been regulated and either prohibited outright or severely limited. Public registered stock offerings are time consuming and expensive with hurdles that restrain early-stage companies from offering public stock (the hurdles can comprise, among others: (a) stock exchange listing requirements, (b) the ongoing cost involved in a meeting the reporting requirements of a publicly reporting company under the Exchange Act; (c) investor skepticism of young and unprofitable companies)

But in a social Internet company, like a social network, the number of users and user data and related contributions can be a significant contributor to value.

Certain exemplary embodiments relate to business development and/or financing especially in the field of social networks and social Internet businesses.

Certain exemplary embodiments involve a significant and novel revision to processes of funding and developing businesses. Certain exemplary embodiments can be applicable to businesses whose product is the data and the activities of the people who use the product; certain of which are social networks and other social Internet companies.

Certain exemplary embodiments utilize a process that is tailored to the social networking business and uses systems that enable that process to work.

Certain exemplary embodiments provide a process and system that utilize novel improvements to hardware and/or software to essentially sidestep certain traditional investors and funding mechanisms (such as involving cash investors) and thereby forms a new model for funding and governing such companies. Certain exemplary embodiments instead, via novel improvements to hardware and/or software, automatically convey common stock directly to the users who register to use the social Internet platform and then contribute data and content to a network.

To understand the iconoclastic nature of this innovation, consider the answer to these questions: How is it possible to primarily fund a business without cash investors? Who would give stock to users just for registering and using the network? Well, think about it. Why does a business need cash when the user is the product? A business needs cash when it is developing, producing and/or delivering a product. But such models are not applicable to a social network or any company where business value is a function of the number of users. There's no need for raw materials, production equipment, plants, warehouses, trucks, stores. You can simply issue shares and pay users for participating. In these social business models, advertisers are the ones who pay cash to the platform operator for access to the users.

To illustrate, imagine if you were establishing a computer manufacturing company. Now, what if you could issue shares of common stock in return for all computers that are produced in the world. Soon you'd have a dominant position in the computer industry. Why? Because you would sell computers for a cash profit while paying common stock for your inventory. You'd pay no cash for your primary expense and receiving cash revenue. In fact, profits on a cash-basis could be huge. That's because once you cover the cost of production, a business has few other uses for cash, other than paying dividends, because there are minimal expenses. Product development and production is the single greatest expense in many businesses.

When a business can use its stock effectively as currency, it has a great advantage. For example, why would a new business that retails computer-hardware sell stock for cash and then use the cash to build plants and hire workers and operate when it could just bypass all of that and buy computers for common stock issued by the business to purchase computers for resale? Using common stock to buy finished product is a perfectly efficient operation because the cost of production is then purely variable. Well, of course, computer manufacturers will not allow a business to buy their production for common stock because: (1) they will need cash (because they pay their investors and their employees in cash); and/or (2) they might believe that having an operating business gives them an advantage against new entrants in the business. It takes years to develop, build and maintain manufacturing facilities, warehouses, and stores. If someone could just come in and buy all the production of that for stock—they would have a huge advantage and could become an instant competitor that could dominate the market.

Historically, companies operating social Internet businesses were developed and funded via sales of common stock to institutional and/or angel investors. As a result, founders, and a relatively small number of early investors in such social networks were able to become large stockholders and generate high returns. The present invention greatly improves upon the traditional funding model and development of the business. The improvement results from recognition that social Internet businesses are different than other businesses because its value is linked to the number of users as well as user provided content and contributions. The social network site operator has an important role in facilitating such content production to create and sustain engagement of users and the network operator ultimately monetizes social interaction. Presently, the network operators take a larger share of economics than justified by their role. Presently social networks take all or most of the net revenue generated by their network when it should be no more than 25%. Let's break it down: First the role of facilitator and in maintaining the network could reasonably command 5% to 10% of total revenue. Second, if the operator were a sales agent for actual producers, the sales agent might receive a commission of approximately 15% (such a commission can be used in other businesses that deal in sales of intangible assets like advertising media sales). Together that means the site operator should receive approximately 20% to 25% of revenues, far less than the 100% they receive now. A remainder of the revenue should go to those who produce the data and the content that makes a social network site valuable.

Certain exemplary economic models were not feasible at certain points in time because:
(1) entrepreneurs were working within parameters of U.S. securities regulations and a financing process and methods that had not changed in any meaningful in approximately 85 years and therefore there were prohibitions to offering common stock to users in a manner that was commercially viable.
(2) There was at times an information disparity between business founders and users, which was exacerbated when users acted as a fragmented group (meaning, even when they have knowledge, they might have little power to bargain against a centralized and determined counterparty).
(3) Even if the playing field was level in terms of process and knowledge, systems were sometimes not be available that could enable the users to execute such transactions in a way that complied with federal and state law. Such an operation requires massive computing power and a large-scale distributed network—all of which did not exist until recently, surely not prior to 2010 to a sufficient extent to make the present invention feasible. The commercial Internet itself is less than 30 years old and is still evolving.

Certain exemplary embodiments advance the state of the art by fusing process innovations that result from recent changes in regulations and systems that enable social networking companies to pay common stock or securities convertible to common stock to users and thereby enable users to benefit economically from their social network by receiving equity in the network and gaining value from both the common stock appreciation and the dividends paid by the social network as well as a participation in governance of the social networking business.

Certain exemplary embodiments are applicable to any company where the value of the company is largely a function of the number of users and their contribution of data and other contributions and where advertisers pay for access to users. In essence, company's where the user is essentially the product.

No other patent provides a funding mechanism for a business that utilizes the methods described herein. U.S. Pat. No. 7,219,071 discloses is a method for rewarding those who buy goods and services. A purpose appears to have been to generate revenue by rewarding customers. This patent included a method that allowed reward recipients to invest their reward in a mutual fund or a common stock program. At the time this patent was issued—it would likely have been illegal for an entity to issue unregistered securities to users and the use of registered securities is prohibitively expensive for new businesses. Even today, the issuance of stock is highly regulated and can only legally occur per very narrow processes permitted by state and federal regulators. The description of U.S. Pat. No. 7,219,071 gives numerous examples—including airline miles and other rewards, which involved consumers first having paid cash for some product or service. That means the product or service must first exist. The present invention the product or service need not be available for purchase before the equity is offered to users.

Certain exemplary embodiments contemplate that a business entity that provides an incentive award via issuance of instruments of ownership, for instance, shares of common stock, in its own equity value or in the equity value of any entity in which the business entity can likewise issue dilutive instruments of ownership. Said equity value can comprise the market capitalization of the entity, namely the sum calculated by multiplying the unit value of said shares as listed on a stock exchange or traded in a private market by the number of the shares outstanding.

Sales of securities are highly regulated under the Securities Act of 1933, as amended. Approximately sixteen years after U.S. Pat. No. 7,219,071 was filed, Regulation CF came into effect on May 16, 2016, which allowed equity crowd funding meaning the offer of unregistered securities to the public. Prior to 2016, sales of unregistered securities could not be made to the public. Furthermore, portfolios of securities and investments are regulated under the Investment Company Act Of 1940 (“ICA”), which requires investment companies to be registered with the regulator under the ICA and governs how investments can be structured, marketed, and sold.

Certain exemplary embodiments provide a method that, via novel improvements to information device hardware and/or software, allows a certain type of early-stage business to be funded rapidly and accelerates development to serve large counts of people.

Businesses can be funded by investors who pay cash for common stock and other securities issued by the business. The cash can be utilized to build infrastructure for production of goods and services and to pay employees involved in producing and delivering the goods and services. In social networks and other social Internet businesses and businesses where value is a function of the number of users, user data, content, and social activity and attention can have value. The present invention

Certain exemplary embodiments describe how the present invention's enhance and improve the funding and development of social businesses and eliminate inefficient steps in the funding and developments process. Certain exemplary embodiments can comprise a company with minimal current value, a funding portal, users of social networks and/or other social businesses and government regulations that raise the barrier to entry by preventing the use of alternative embodiments.

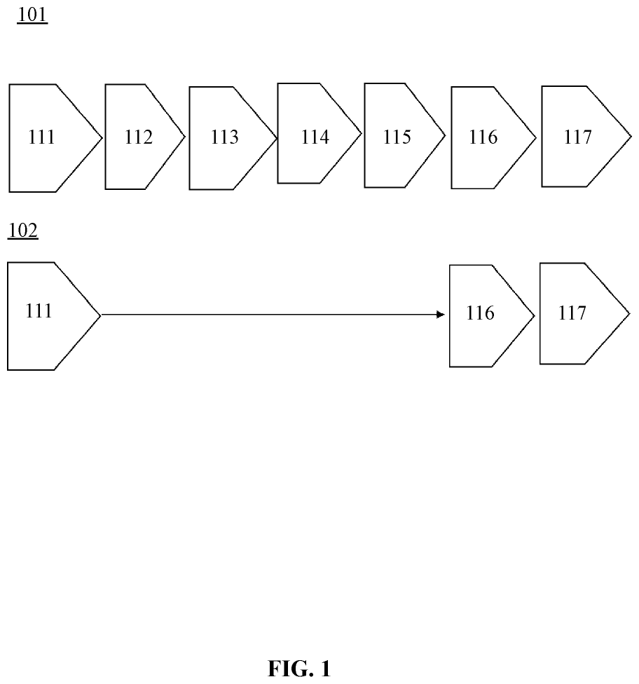

FIG. 1 illustrates two flowcharts of exemplary embodiments of methods, which comprises the flowing activities:
111. Business Plans to Sells Stock to Start Social Network;
112. Investors buy stock for cash;
113. Business uses cash to develop the business—including marketing to attract users
114. Business does another round of funding and receives cash proceeds
115. Business expands outside the USA and uses funds to attract users outside the USA
116. Users now number in the millions and produce data and content needed for the company to make a profit.
117. Business board approves a dividend distribution to shareholders

The first exemplary embodiment of a method 101 illustrates activities 111, 112, 113, 114, 115, 116, and 117 proceeding sequentially.

The second exemplary embodiment of a method 102 illustrates activities 111, 116, and 117 proceeding sequentially. Method 102 is implemented via novel improvements to the hardware and/or software of exemplary information devices. Such improvements allow improved information devices to automatically grant stock to users in exchange for user provided data. Such information devices can, responsive to a user query, automatically render a graphic user interface (“GUI”) on an I/O device. The GUI comprises an element that requests a user response indicative of a desire to receive a common stock grant in return for certain action or activity. Responsive to a favorable user response, the GUI is automatically modified and requests the user provide information related to granting common stock (e.g., tax id numbers, address information, etc.). The site operator establishes predetermined criteria for the granting of common stock and embodies those criteria into hardware and/or software that generate the GUI.

Once a common stock election is made, the GUI is modified to query a user to satisfy predetermined data criteria to be granted stock. Responsive to each data entry provided by the user, the GUI causes site operator records to be automatically updated for both data content as well as a degree of compliance with criteria for common stock grants. Once criteria for common stock grants are satisfied, the GUI is modified to advise the user of automatic common stock issuance.

In certain exemplary embodiments, method 102 affords a benefit of saving between approximately two to five years of time and reducing risk.

Referring to FIG. 1, method 101 shows the steps that would be taken in a process. In method 101, activities 111, 112, 113, 114, 115, 116, and 117 describe steps in a sequence, although it is not necessary that the sequence necessarily be in that order. By comparison, method 102 shows the steps when using an exemplary embodiment. Noticeably, more than half the steps are eliminated using method 102. The business can go from 101 directly to 116. The business thereby benefits by saving time, we estimate approximately two to six years, saving money by reducing the transaction costs that each round of funding entail, and by reducing risk because the business achieves profitability faster.

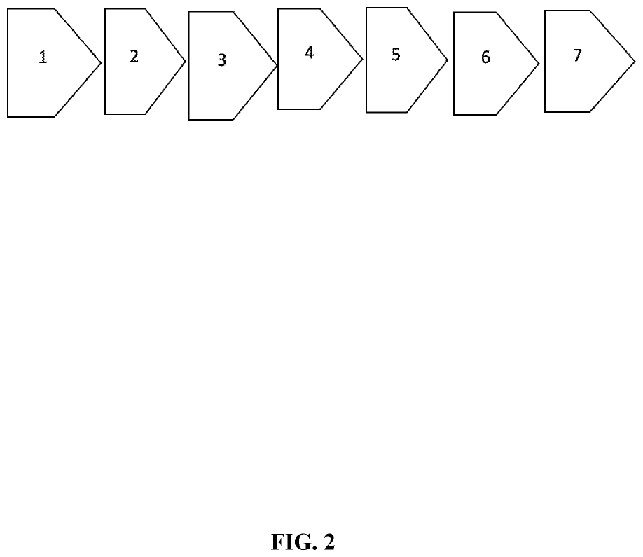

FIG. 2 illustrates a flowchart of an exemplary embodiment of a method, which includes activities:
1. User Visits Internet Page with Calculator & Input Screen;
2. User Indicates Interest by Inputting Personal Data and Signup;
3. Many Users Register and set up Profiles on Network;
   It takes large counts of users to create a viable network site;
4. User uses Profile Number at Funding Portal to get common stock offer document;
   Social Network Offers Shares Through The Funding Portal;
5. User Accepts the Shares of Common Stock;
6. Shares are Transferred Either to the User or the User's Account at a Registered Investment Co.

FIG. 2 shows a flow chart that illustrates the steps a business might take in an exemplary embodiment to offer shares of common stock or other equity-related securities to users of a social business. It is not necessary that the steps be in a specific sequential order—although some steps logically would precede or follow others. Some of the steps can be grouped together and titled “test the waters” and others “funding”. For sake of illustration and easy of display, the number of steps has been condensed, truncated, simplified and, or, grouped. In method 201, steps 1 to 5, are titled “test the waters” which is a process whereby the business can solicit indications of interest from users to determine if enough users are interested in its offering of equity in the social business. This step is important because, in social businesses scale is important in achieving valuable effects and economies that reduce unit costs of site operation. The business might wait to issue equity until after it has achieved a threshold that puts it in a strong competitive position. This step can therefore reach out to many users, potentially millions of users, to solicit their interest and that scope can be accomplished with technology and information processing systems that are customized to the task, which systems are disclosed herein. A next group of steps can be called “Funding”; this group of steps is the actual offering and distribution of equity securities. This group of steps can utilize technologies and systems to transfer equity to multiple people. The sequence of steps displayed is simply one possible embodiment and there may come a time when some steps can be better streamlined or even eliminated.

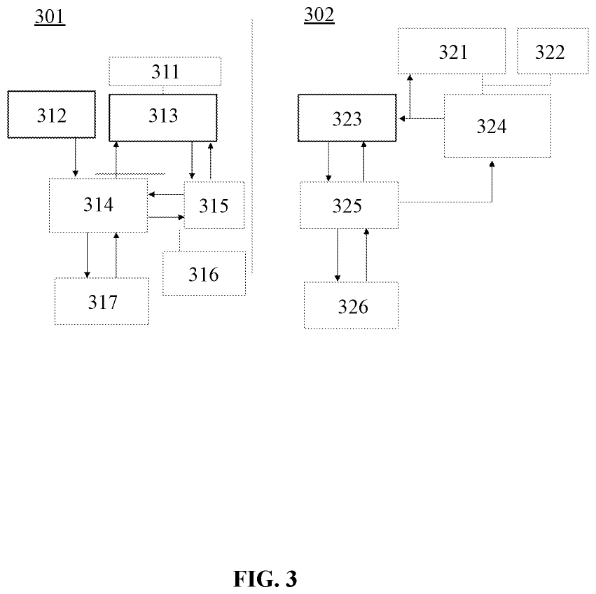

FIG. 3 illustrates two flowcharts of exemplary embodiments of methods. FIG. 3 shows a block chart that illustrates the methods of business operating and funding structure of certain businesses versus businesses that utilizes funding according to an exemplary embodiment. Differences in efficiency and equity are clear in this comparison as is the overall method and its component processes and systems. The thing that stands out in this comparison is the separation between user and owner in certain methods. That separation can be due to a wide range of factors. By comparison, certain exemplary embodiments can combine user and owner so that there is no separation. Method 301 displays the parties and their interaction using a predetermined method. For ease of illustration much of the structure and interaction is simplified. Method 301 comprises accounts at investment companies 311, users 312, owners 313, a social network 314, banks and brokers 315, advertisers 317, and a transfer agent 316. Users 312 contribute data and content to social network 314. That data can be monetized by selling advertising to advertisers 317. A similar process occurs in method 302 in which users contribute data and can be monetized through a sale of advertising. Method 302 comprises accounts at investment adviser 321, a transfer agent 322, users/owners 323, a funding portal 324, a social network 325, and advertisers 326. Funding portal 324 is operated by a security law compliance entity. The difference between method 301 and method 301 is in who receives the net proceeds of the advertising in the form of dividends. In method 301, dividends can be paid to owners 313. In method 302, the dividends can be paid to users/owners 323. The presented chart shows one embodiment and there can be other variations such as method 302 comprising a separate class of common stock, which can be purchased by cash investors and thereby a portion of dividends may be paid to owners who are not users.

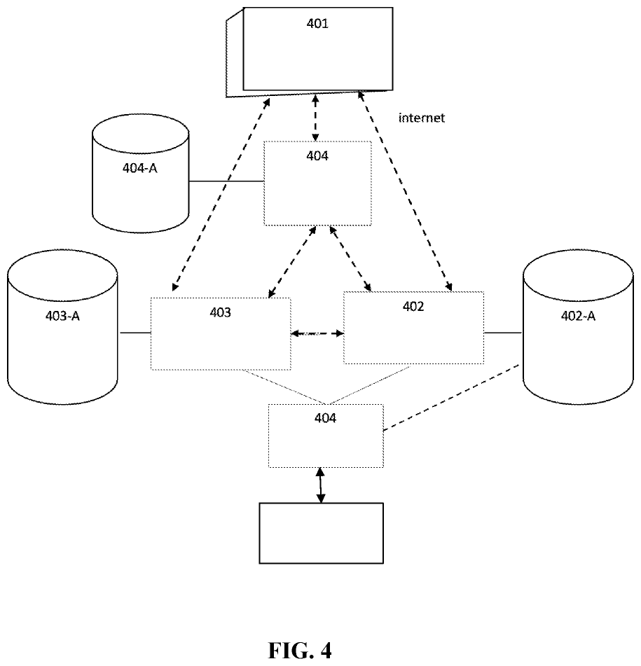

FIG. 4 illustrates a block diagram of an exemplary embodiment of a system and data flow in the system. FIG. 4 illustrates a block chart that illustrates the data flow and the systems that enable exemplary embodiments to achieve the commercially viable results. The process starts with people using a user interface 401 (e.g., an input screen or graphic user interface) with fields that prompt input of personal information such as name and date of birth. The people who use the screen do so because they are interested in receiving stock in return for registering for the social internet business and may include setting up a profile on the business website or otherwise showing some initial use. The screen inputs go to a social Internet business processor 402, which processes and stores the data in a memory device 402-A. Memory device 402-A can be a physical or cloud-based server or other memory device. When a threshold count of interested users is achieved, the user and the social Internet business interact with a funding portal processor 403. Funding portal processor 403 collects data via an electronic coupling with both parties and then sends securities offering documents to a user information device 405 via email or secured link or other electronic process. If a user approves an offering, Funding portal processor 403 modifies a user interface to request and collect additional information, which is automatically transmitted to social Internet business processor 402, the social business, and to 404, the transfer agent. Both the business and transfer agent update database records to reflect the new shareholder. The User may elect to have their shares held by a transfer agent 404 (e.g., an investment company) and, if so, funding portal processor 403 and transfer agent 404 initiate the transfer and automatically update their database records and the investment company records are automatically updated.

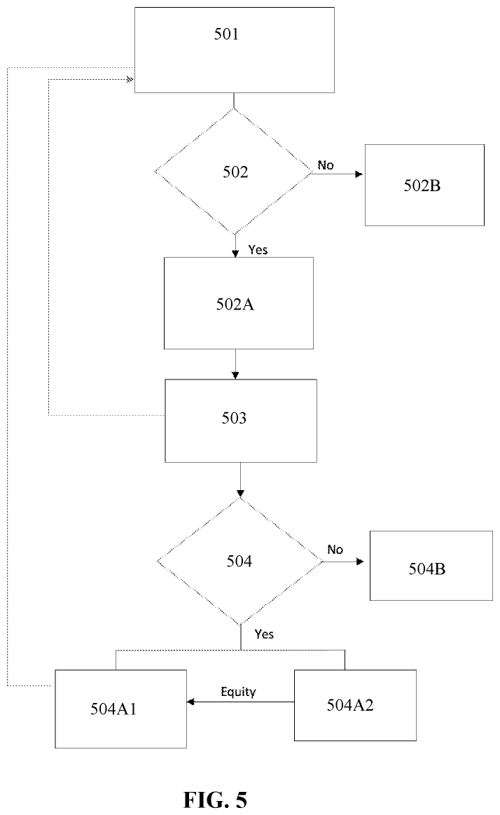

FIG. 5 illustrates a block diagram of an exemplary embodiment of a system decision framework. FIG. 5 illustrates a decision flow chart that illustrates the user's decision process and available interfaces for information and data input. The user is an individual who is eligible to receive stock under applicable securities laws. Start with an eligible individual 501 (e.g., an individual residing in a jurisdiction allowing common stock transfer where the person is of legal age to receive such a transfer—18 years old in many jurisdictions) making a decision 502, as to whether they want to own a stake in their social network. Individual 501 can reach this decision point after being contacted by a company's marketing efforts and may have expressed interest in such a proposal and/or signed up for more information. If they choose not to be an owner, the process ends at activity 502B. If they chose to be an owner, a specific graphical user interface (“GUI”) is rendered, which causes the user to register with the social network and set up a social user profile 502A. As a result of a registration process that comprises social user profile 502A, the user can receive a social account identification number. When the user sets up the user profile, the user receives a user account number (“UAN”) via the GUI, which has been automatically modified by novel hardware and/or software that changes and improves the functionality of information devices. The GUI then automatically renders a funding platform 503 via which additional data is input to set up an account. The user inputs the UAN as proof of their having completed the tasks for which made them eligible for stock. Once requested inputs are provided, the user receives a prospectus, or other written document, for the equity securities via funding platform 503. The user evaluates the offering document and decides if they want to accept or decline it at decision 504. The user decides within a predetermined time period. If the user does not respond within the allowed time or declines the offer the process ends at activity 504B. If the user accepts the offer, the user's information will be forwarded to an investment company account 404A1 or a transfer agent 404A2 and the equity, such as shares of common stock, will be sent to an investment advisor firm where the user has an account or where an account is established by the user. The equity can convey to the user governance rights and/or dividend rights.

Certain exemplary embodiments were not feasible in the United States before securities regulations were changed by the Securities and Exchange Commission a change that became effective only on Mar. 15, 2021. See https://www.crowdfundinsider.com/2020/11/168682-the-sec-updates-reg-cf-reg-a-and-more-boosts-reg-cf-to-5-million-reg-a-increased-to-75-million/; and https://www.federalregister.gov/documents/2021/01/14/2020-24749/facilitating-capital-formation-and-expanding-investment-opportunities-by-improving-access-to-capital.

Certain exemplary embodiments utilize detailed expertise and knowledge of multiple separate and distinct fields of business, law and finance including the social internet business, early-stage business financing, economics, marketing, securities law, corporate law, computer systems. Experts in any one or two of these areas would not have been in a position to “connect the dots” so as to create exemplary methods disclosed herein. Very few people have the interdisciplinary knowledge, the insight and creativity to create the disclosed exemplary methods. Regulation has restricted use of certain exemplary embodiments of configurations, or made them infeasible, in the past.

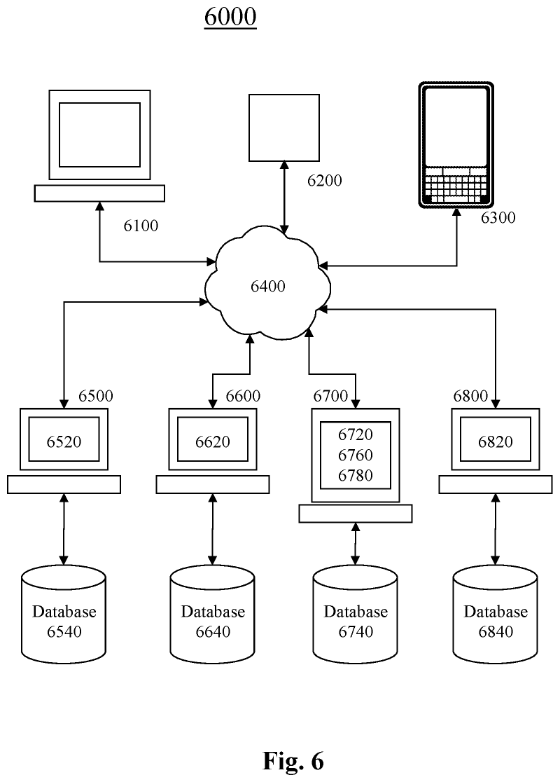

FIG. 6 is a block diagram of an exemplary embodiment of a system 6000, which can comprise a smartphone 6300, an information device 6100, tablet 6200, a network 6400, a first server 6500, a second server 6600, a third server 6700, and a fourth server 6800. First server 6500 can comprise a first user interface 6520 and can be coupled to a first database 6540. Second server 6600 can comprise a second user interface 6620 and can be coupled to a second database 6640. Third server 6700 can comprise a third user interface 6720, a processor 6760, machine instructions 6780, and can be coupled to a third database 6740. Fourth server 6800 can comprise a fourth user interface 6820 and can be coupled to a fourth database 6840. Any of the methods and/or steps thereof can be carried out in whole or in part by tablet 6200, smartphone 6300, information device 6100 and/or first server 6500. Second server 6600, third server 6700, and/or fourth server 6800 can each be associated with implementation of a system via which rides are provided to customers. In certain exemplary embodiments, system 6000 can be used to implement one or more methods disclosed herein.

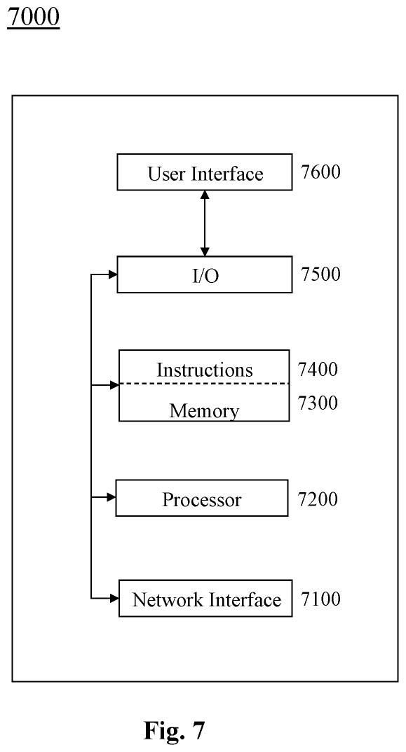

FIG. 7 is a block diagram of an exemplary embodiment of an information device 7000, which in certain operative embodiments can comprise, for example, first server 6500 and user information device 6100 of FIG. 6. Information device 7000 can comprise any of numerous circuits and/or components, such as for example, one or more network interfaces 7100, one or more processors 7200, one or more memories 7300 containing instructions 7400, one or more input/output (“I/O”) devices 7500, and/or one or more user interfaces 7600 coupled to one or more I/O device 7500, etc.

In certain exemplary embodiments, via one or more user interfaces 7600, such as a graphical user interface, a user can view a rendering of information related to ownership of social Internet entities.

Information device 7000, as utilized to implement the methods disclosed herein, improves computer functionality and results in specific improvements to computer functionality. The hardware and/or software utilized to implement methods disclosed herein improves upon prior art social media stock ownership systems by employing a proprietary and flexible stockholder table to automatically issue shares and record those shares within the proprietary stockholder table. Certain exemplary embodiments provide specific implementations of solutions to problems in hardware and/or software applications concerning share issuance in social media companies.

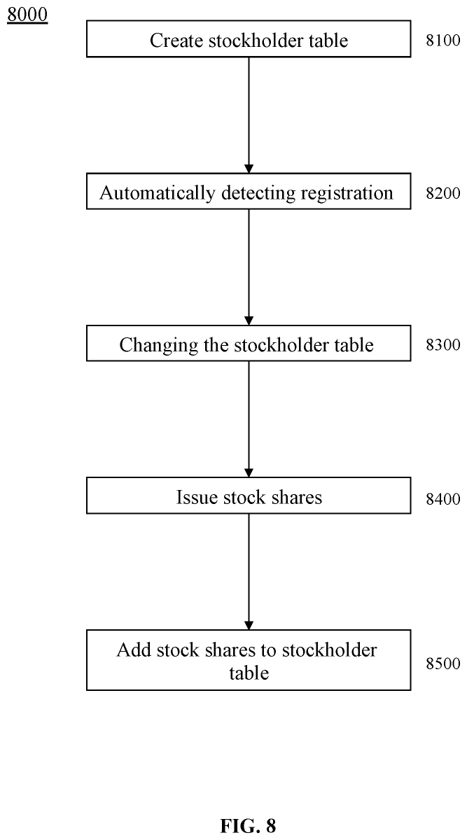

FIG. 8 is a flowchart of an exemplary embodiment of a method 8000. At activity 8100, a stockholder table is created. The stockholder table is created and maintained on a machine-readable medium.

At activity 8200, a registration for, and use of, a subscription service accessed via the Internet by a user is automatically detected.

At activity 8300, responsive to detected registration for, and use of, the subscription service, the stockholder table is automatically changed to add the user as a shareholder of the subscription service.

At activity 8400, responsive to detected registration for, and use of, the subscription service, stock shares of the subscription service are issues to the user.

At activity 8500, responsive to detected registration for, and use of, the subscription service, the stockholder table is changed to add stock shares to the user in the stockholder table.

In certain exemplary embodiments, the stock shares are preferred stock and/or the preferred stock is convertible to common stock via a digital instrument. In certain exemplary embodiments, the stock shares are convertible to common stock via a digital instrument and/or the digital instrument comprises a cryptographic process.

In certain exemplary embodiments, the stock shares are convertible to common stock via a digital instrument and the digital instrument constructed using a Blockchain technology.

In certain exemplary embodiments, the user is granted voting rights in the subscription service and/or the voting rights include a right to vote for members of a board of directors of the subscription service. In certain exemplary embodiments, the user is granted voting rights in the subscription service and members of a board of directors of the subscription service are selected by sortition.

In certain exemplary embodiments, the method is performed via machine instructions that assign stock shares based upon:
a predetermined maximum count of stock shares of the subscription service; and/or
a preference to assign stock shares to as many users as possible.

In certain exemplary embodiments, initial costs of the subscription service are paid with debt.

In certain exemplary embodiments, the subscription service has a net valuation of less than a predetermined maximum when stock shares are assigned to the user in the stockholder table.

In certain exemplary embodiments, stock shares are assigned to the user in the stockholder table based upon a test-the-waters campaign.

In certain exemplary embodiments, stock shares are assigned to the user in the stockholder responsive to an election of the user.

In certain exemplary embodiments, stock shares are assigned to the user via a funding portal.

In certain exemplary embodiments, the user sets up a profile and/or the user receives a social profile code.

In certain exemplary embodiments, stock shares are assigned to the user via a funding portal and/or the user is prompted by the funding portal to set up a profile.

In certain exemplary embodiments, stock shares are assigned to the user via a funding portal and/or the user receives a stock offering document via the funding portal.

In certain exemplary embodiments, stock shares are assigned to the user via a funding portal; the user receives a stock offering document via the funding portal; the user has a predetermined period of time to review the stock offering document; and/or the user returns to the funding portal to accept the stock shares.

In certain exemplary embodiments, stock shares are assigned to the user via a funding portal; the user receives a stock offering document via the funding portal; the user has a predetermined time period to review the stock offering document; the user returns to the funding portal to accept the stock shares; and/or the funding portal automatically changes the stockholder table upon acceptance of the stock shares by the user.

In certain exemplary embodiments, the user has a third party hold the stock shares.

In certain exemplary embodiments, the stock shares are issued responsive to the user providing information via a rendered user interface.

In certain exemplary embodiments, the stock shares are issued responsive to the user providing information via a rendered user interface, the user interface provided via the Internet.

In certain exemplary embodiments, the stock shares are issued responsive to the user providing information via a rendered user interface, the user interface provided via the Internet.

In certain exemplary embodiments, machine instructions calculate a value of a contribution of the user to:
determine a count of stock shares issued to the user; and/or
render to the user the value of the contribution of the user to the subscription service

In certain exemplary embodiments, the stock shares are issued in a form of a digital token that utilize cryptography to allow for secure transactions and ease of transfer.

In certain exemplary embodiments, the stock shares in a tokenized form can be transferred in electronic form among and between user accounts, or digital wallets, in a centralized system which is provided by a financial institution or in a decentralized system in which users transfer between and among each other's digital wallets.

In certain exemplary embodiments, the stock shares are issued in a form of a token that is digitized for ease of transfer from one computer system to another and for storage in a computerized database.

In certain exemplary embodiments, the stock shares are issued in a form of a token that is digitized for ease of transfer from one computer system to another and for storage in a computerized database and/or the token is constructed utilizing any cryptographic code based on Blockchain technology.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
accept—to agree to do something.
access—an ability to communicate with.
activity—an action, act, step, and/or process or portion thereof.
add—to include something in a system.
and/or—either in conjunction with or in alternative to.
apparatus—an appliance or device for a particular purpose.
as many as possible—as high a count as can be achieved.
assign—to designate.
associate—to join, connect together, and/or relate.
automatically—acting or operating in a manner essentially independent of external influence or control. For example, an automatic light switch can turn on upon “seeing” a person in its view, without the person manually operating the light switch.
based upon—used as a criterion for a determination.
Blockchain—a system of recording information using an cryptographic algorithm that makes it difficult or impossible to change, hack, or cheat the system. A Blockchain is essentially a digital ledger of transactions that is duplicated and distributed across the entire network of computer systems. It can be used to create a token. The token can represent anything the creator assigns to the token, such as a monetary unit or a share of stock. It can also be used to link information in a database containing information (such as records of financial transactions). Blockchain-based systems can be function as centralized or decentralized systems. Decentralized systems are those with no central issuer, administrator or custodian and are primarily used when anonymity is a key objective of the token users, such as in currency transactions. Centralized systems are used when there are centralized users, administrators, transfer agents or custodians and are primarily used when anonymity is not a key objective of token users.
board of directors—a group of people who manage or direct a company or organization.
calculate—compute.
can—is capable of, in at least some embodiments.
change—to make different.
common stock—stock other than preferred stock.
comprising—including but not limited to.
configure—to make suitable or fit for a specific use or situation.
constructed to—made to and/or designed to.
contribution—to supply something of value.
convert—to transform, adapt, and/or change.
count—a defined quantity.
create—to bring into being.
cryptographic code—machine instructions that encrypt.
cryptographic method—a process that makes data unreadable or undecipherable by anyone except an authorized recipient in event that a message is intercepted by someone else.
cryptography—data encryption.
data—distinct pieces of information, usually formatted in a special or predetermined way and/or organized to express concepts.
debt—an amount of money that is owed.
define—to establish the outline, form, or structure of.
detect—to sense or perceive.
determine—to obtain, calculate, decide, deduce, and/or ascertain.
device—a machine, manufacture, and/or collection thereof.
digital—non-analog; discrete.
digital token—a digital representation of value or rights that is offered and sold for the purpose of: facilitating access to, participation in, or development of a distributed ledger, Blockchain, or other digital data structure; and/or raising capital for the development of a network or platform.
document—a physical and/or electronic collection of related data elements.
election—price.
estimate—to calculate and/or determine approximately and/or tentatively.
funding portal—a user interface that is constructed to issue stock. Such portals are authorized by securities regulators pursuant to applicable law.
generate—to create, produce, give rise to, and/or bring into existence.
grant—to permit as a right.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
initial cost—a value owed at a beginning of a business.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general, any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instrument—a device and/or system constructed to perform a specific process.
issue—to give out.
less than—lower in magnitude.
machine instructions (i.e., “software”)—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
maintain—to support and keep current.
maximum—a greatest extent.
may—is allowed and/or permitted to, in at least some embodiments.
member—an individual comprised by a group.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
net valuation—an amount of determined equity less an amount of debt owed.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
paid—money conveyed to an entity.
perform—to accomplish something.
plurality—the state of being plural and/or more than one.
predetermined—established in advance.
preferred stock—stock guaranteed priority by a corporation's charter over common stock in the payment of dividends and usually in the distribution of assets.
preference—a priority in consideration.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, California. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
profile—a set of data exhibiting significant features of a user, typically including personal details of a user such as date of birth, citizenship or place of birth.
project—to calculate, estimate, or predict.
provide—to furnish, supply, give, and/or make available.
receive—to get as a signal, take, acquire, and/or obtain.
recommend—to suggest, praise, commend, and/or endorse.
register—to formally enroll in a system, the system comprising records.
registration—the act of registering which typically involves, among other things, a prospective customer providing to the corporation the customer's name, address, phone number and other personal data that is often stored in a customer relationship management (CRM) database by which a company can, among other things, know its customers, can track their use of services and provide personalized customer services.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
responsive—reacting to an influence and/or impetus.
return—to go back to something.
review—a to go over or examine critically or deliberately.
right—a privilege given to a stockholder.
select—to choose from a plurality of alternatives.
service—an activity provided for the benefit of another.
set—a related plurality.
set up—to assemble and arrange.
share—any of the equal interests or rights into which the entire stock of a corporation is divided and ownership of which is regularly evidenced by one or more certificates.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
social profile code—a designation that is used by groups of people to designate a class of information of one or more users.
sortition—an act of selecting one or more from a larger group using a selection process; often such as a process involves selecting based on a random choice.
stock—a proprietorship element in a corporation, which can take a form of common or preferred or a hybrid security (meaning a any security that is convertible, exchangeable or exercisable into any common stock or any preferred stock)—each of which can be segmented into different classes with various rights for each such class which rights are determined by the board of directors of the corporation prior to issuance and transfer to investors. Stock is usually divided into physical certificates that represent a holder's share of the ownership of the corporation and alternatively ownership of stock can be recorded in the corporation's stock ledger which is referred to as “book entry” means of representing ownership.
stock offering document—a writing that provides criteria and/or rules about a potential to obtain stock.
stockholder table—a table that identifies shareholders and a count of shares held by each shareholder.
store—to place, hold, and/or retain data, typically in a memory.
subscription—a business model in which a customer registers for, and uses, an interne service and the customer may or may not, pay cash for the service.
substantially—to a great extent or degree.
system—a collection of mechanisms, devices, machines, articles of manufacture, processes, data, and/or instructions, the collection designed to perform one or more specific functions.
table—data arranged in physical and/or logical rows and columns.
test-the-waters—a campaign compliant with Securities and Exchange Commission regulations that have been assigned the moniker “test the waters”.
third party—an entity other than a principal to a transaction.
time period—a time interval.
token—a tangible or intangible thing representing a tangible or intangible item of value, a concept, a feeling or an idea.
transmit—to send as a signal, provide, furnish, and/or supply.
use—to utilize something for a particular purpose.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
utilize—to put to use.
value—worth.
via—by way of and/or utilizing.
vote—to express an enumerated wish or choice.
voting rights—one form of governance rights of shareholders or directors to vote on corporate matters.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
creating a stockholder table, the stockholder table created and maintained on a machine-readable medium;
automatically detecting registration for, and use of, a subscription service accessed via the Internet by a user;
responsive to detected registration for, and use of, the subscription service, automatically changing the stockholder table to add the user as a shareholder of the subscription service;
responsive to detected registration for, and use of, the subscription service, automatically changing the stockholder table to issue stock shares of the subscription service to the user; and
responsive to detected use of, the subscription service, automatically changing the stockholder table to add stock shares to the user in the stockholder table.

2. The method of claim 1, wherein:
the stock shares are preferred stock.

3. The method of claim 1, wherein:
the stock shares are preferred stock; and
the preferred stock is convertible to common stock in the form of, or via, any digital instrument, such as a security token.

4. The method of claim 1, wherein:
the stock shares are convertible to common stock in the form of, or via, any digital instrument, such as a security token; and
the digital instrument comprises a cryptographic process.

5. The method of claim 1, wherein:
the stock shares are convertible to common stock in the form of, or via, any digital instrument, such as a security token; and
the digital instrument constructed using a Blockchain technology.

6. The method of claim 1, wherein:
the stock grants the user governance rights in the subscription service; and
the governance rights are in the form of voting rights include a right to vote for members of a board of directors of the subscription service.

7. The method of claim 1, wherein:
the stock grants the user governance rights in the subscription service; and
the governance rights take the form of sortion where by those selected either become members of the board of directors or form a committee that chooses one, or more, of its members to sit on the board of directors.

8. The method of claim 1, wherein:
the method is performed via machine instructions that assign stock shares based upon:
a predetermined maximum count of stock shares of the subscription service; and
a preference to assign stock shares to as many users as possible.

9. The method of claim 1, wherein:
initial costs of the subscription service are paid with debt.

10. The method of claim 1, wherein:
the subscription service has a net valuation of less than a predetermined maximum when stock shares are assigned to the user in the stockholder table.

11. The method of claim 1, wherein:
stock shares are assigned to the user in the stockholder table based upon a “test-the-waters” campaign to the extent permitted under US Securities regulations and where such regulations permit the use of general advertising.

12. The method of claim 1, wherein:
stock shares are assigned to the user in the stockholder table responsive to an election of the user.

13. The method of claim 1, wherein:
stock shares are assigned to the user via a funding portal.

14. The method of claim 1, wherein:
the user sets up a profile; and
the user receives a social profile code.

15. The method of claim 1, wherein:
stock shares are assigned to the user via a funding portal; and
the user is prompted by the funding portal to set up a profile.

16. The method of claim 1, wherein:
stock shares are assigned to the user via a funding portal; and
the user receives a stock offering document via the funding portal.

17. The method of claim 1, wherein:
stock shares are assigned to the user via a funding portal;
the user receives a stock offering document via the funding portal;
the user has a predetermined period of time to review the stock offering document; and
the user returns to the funding portal to accept the stock shares.

18. The method of claim 1, wherein:
stock shares are assigned to the user via a funding portal;
the user receives a stock offering document via the funding portal;
the user has a predetermined time period to review the stock offering document;
the user returns to the funding portal to accept the stock shares; and
the funding portal automatically changes the stockholder table upon acceptance of the stock shares by the user.

19. The method of claim 1, wherein:
the user has a third party hold the stock shares.

20. The method of claim 1, wherein:
the stock shares are issued responsive to the user providing information via a rendered user interface.

21. The method of claim 1, wherein:
the stock shares are issued responsive to the user providing information via a rendered user interface, the user interface provided via the Internet.

22. The method of claim 1, wherein:
the stock shares are issued responsive to the user providing information via a rendered user interface, the user interface provided via the Internet.

23. The method of claim 1, wherein:
machine instructions calculate a value of a contribution of the user to:
determine a count of stock shares issued to the user; and
render to the user the value of the contribution of the user to the subscription service.

24. The method of claim 1, wherein:
the stock shares are issued in a form of a digital token that utilize cryptography to allow for secure transactions and ease of transfer.

25. The method of claim 1, wherein:
the stock shares in a tokenized form can be transferred in electronic form among and between user accounts, or digital wallets, in a centralized system which is provided by a financial institution or in a decentralized system in which users transfer between and among each other's digital wallets.

26. The method of claim 1, wherein:
the stock shares are issued in a form of a token that is digitized for ease of transfer from one computer system to another and for storage in a computerized database.

27. The method of claim 1, wherein:
the stock shares are issued in a form of a token that is digitized for ease of transfer from one computer system to another and for storage in a computerized database; and
the token is constructed utilizing any cryptographic code based on Blockchain technology.

28. The method of claim 1, whereby subscribers have, or open, accounts with one registered investment adviser that holds their shares and administers their account.
